(19) United States
(12) Patent Application Publication
(10) Pub. No.: US 2015/0356915 A1
(43) Pub. Date: Dec. 10, 2015

(54) Active Matrix LED Pixel Driving Circuit And Layout Method

(71) Applicant: Kopin Corporation, Westborough, MA (US)

(72) Inventors: Yong Seok Seo, Palo Alto, CA (US); Jin Kuk Kim, San Jose, CA (US); Seung Youb Kim, Fremont, CA (US); Jang Ho Kim, San Jose, CA (US)

(21) Appl. No.: 14/732,058

(22) Filed: Jun. 5, 2015

Related U.S. Application Data
(60) Provisional application No. 62/008,452, filed on Jun. 5, 2014.

(51) Int. Cl. G09G 3/32

(52) U.S. Cl. CPC G09G 3/3225; G09G 3/3241; G09G 3/3258; G09G 2320/0233; G09G 2300/0842; G09G 2300/0866; G09G 2300/0439

(57) ABSTRACT

Embodiments provide an active matrix LED pixel driving circuit and pixel layout for increased uniform illumination of LED display panels. A plurality of sub driving transistors can be located in neighbor pixels of the pixel associated with the prime driver transistor's LED. The sub driving transistors can compensate for the process variations affecting the threshold voltage variation of the prime driver transistor resulting in uniform illumination of LED's on the display panel.

### RELATED APPLICATION(S)

This application claims the benefit of U.S. Provisional Application No. 62/008,452, filed on Jun. 5, 2014. The entire teachings of the above application(s) are incorporated herein by reference.

### BACKGROUND OF THE INVENTION

A typical active matrix light emitting diode (LED) display uses a matrix of pixels that include a capacitor charged by a driving voltage. The pixels of the active matrix LED display use the stored voltages until the scan period of the next frame. These stored voltages allow the pixel circuit to drive the current to an LED during the one frame time period.

With reference to FIG. 1, a typical pixel in the prior art comprises a first transistor 11 and a second transistor 12, a capacitor 13, and an LED 14. The gate of the first transistor 11 receives a select signal through a Select Line (SL) 16 while the source of the first transistor 11 receives a voltage data signal through a VData line 17. The voltage data signal is transmitted to the gate of the second transistor 12 when the first transistor 11 is turned on by the select signal, and the voltage level of the data signal Vdata turns on the second transistor 12 to generate a driving current through the second transistor 12 illuminating the LED 14 during the one frame time period. A typical prior art layout of the pixels in shown in FIG. 2, with a plurality of pixels 201-215 being placed in a grid pattern with a plurality of select lines 250a-250c for the rows and a plurality of voltage data lines 260a-260e for the columns.

However, the typical pixels in FIG. 1, and as they are placed in the layout of FIG. 2, suffer from drift and the second transistors' threshold voltage variation, including as caused by width variation and length variation, which can result in variation of the driving current. The variations between the driving currents in the different pixels can cause non-uniform illumination on the display panel or screen.

### SUMMARY OF THE INVENTION

Embodiments of the present invention relate to an active matrix LED pixel driving circuit and pixel layout that provide increased uniform illumination of LED display panels. In accordance with one example embodiment, a light emitting diode pixel driving circuit includes a first prime driving transistor having a first gate and a first source, a select line connected to the first gate, a voltage data line connected to the first source, a second prime driving transistor having a second gate and a second drain, a light emitting diode connected to the second drain, and a plurality of sub driving transistors each having a gate and a drain wherein the gates of the plurality of sub driving transistors are connected to the second gate and the drains of the sub driving transistors are connected to the second drain.

For certain embodiments, the first and second prime driving transistors are located in a first pixel and the plurality of sub driving transistors are located outside the first pixel. For certain example embodiments, the first and second prime driving transistors are located in a first pixel and each of the plurality of sub driving transistors are located in a neighbor pixel to the first pixel. For certain embodiments, the first and second prime driving transistors are P-channel transistors. For additional example embodiments, the plurality of sub driving transistors are each P-channel transistors.

For certain example embodiments, the second prime driving transistor also has a second source and the example circuit further includes a capacitor connected between the second source and the second gate. For certain embodiments, the second prime driving transistor also has a second source and further included is a VDD voltage source that is connected to the second source. For additional example embodiments, the plurality of sub driving transistors also each have a source and the VDD voltage source is also connected to the sources of the plurality of sub driving transistors. For certain embodiments, the first gate is capable of receiving a select signal through the select line and the first source is capable of receiving a voltage data signal through the voltage data line.

Yet for still other additional embodiments, the voltage data signal is transmitted to the second gate when the first prime driving transistor is turned on by the select signal, and the voltage level of the voltage data signal is configured to turn on the second prime driving transistor to generate a driving current through the second prime driving transistor. For certain example embodiments, the plurality of sub driving transistors are capable of compensating for a threshold variation of the second prime driving transistor resulting in an improved uniform illumination of the light emitting diode on a display panel.

Another example embodiment of the present invention is a method that includes receiving a select signal at a first gate of a first prime driving transistor to turn on the first prime driving transistor, transmitting a voltage data signal to a second gate of a second prime driving transistor and to each of a plurality of gates of a plurality of sub driving transistors when the first prime driving transistor is turned on by the select signal, generating a driving current through the second prime driving transistor when the voltage data signal turns on the second prime driving transistor, illuminating a light emitting diode using the driving current, and wherein the plurality of sub driving transistors also each have a drain which are connected to the second drain of the second prime driving transistor, and the plurality of sub driving transistors compensate for a threshold variation of the second prime driving transistor. For field effect transistors (FET) transistors, the threshold voltage is the minimum voltage difference between the gate and source that is needed to create a conducting path between the source and drain.

For certain embodiments, the first and second prime driving transistors are located in a first pixel and the plurality of sub driving transistors are located outside the first pixel. For certain embodiments, the first and second prime driving transistors are located in a first pixel and each of the plurality of sub driving transistors are located in a neighbor pixel to the first pixel.

For additional embodiments, the first and second prime driving transistors are P-channel transistors and/or the plurality of sub driving transistors are each P-channel transistors. For certain embodiments, the second prime driving transistor also has a second source and further comprises providing current to the light emitting diode from a capacitor which is connected between the second source and the second gate when the first prime driving transistor is turned off. For certain example embodiments, the second prime driving transistor also has a second source and the plurality of sub driving transistors also each have a source, and a VDD voltage source is connected to the second source and to the sources of the plurality of sub driving transistors. For some example embodiments, the select signal is received through a select line and the voltage data signal is transmitted through a voltage data line. For certain example embodiments, the plurality of sub driving transistors compensate for a threshold variation of the second prime driving transistor so as to result in an improved uniform illumination of the light emitting diode on a display panel.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a schematic of a prior art LED pixel driving circuit.

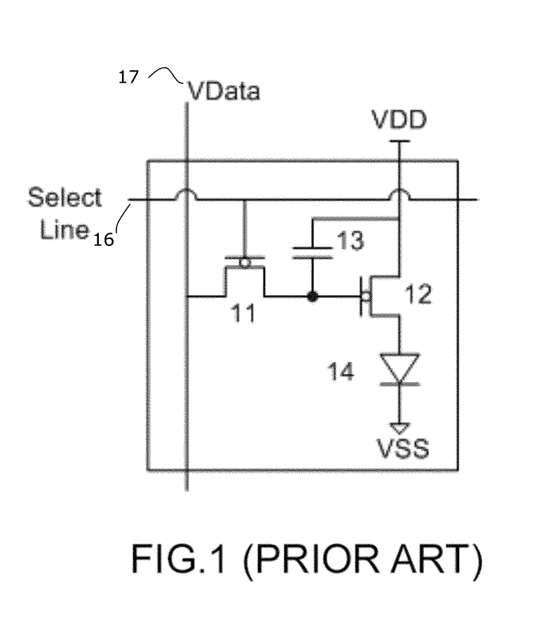

FIG. 2 is a prior art circuit diagram of an LED pixel matrix.

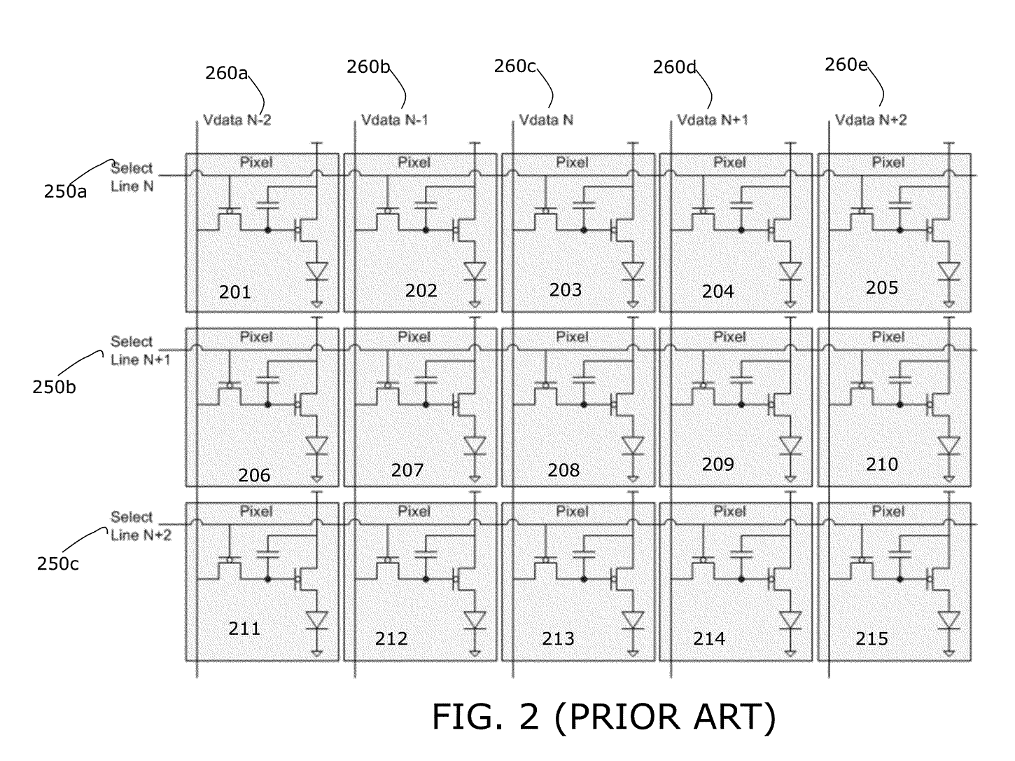

FIG. 3 is a schematic of a LED pixel driving circuit in accordance with an embodiment of the present invention.

FIG. 4 is a circuit diagram of an LED pixel matrix in accordance with an embodiment of the present invention.

FIG. 5 is a flow diagram illustrating an example embodiment of a method relating to LED pixel driving circuits in accordance with embodiments of the present invention.

### DETAILED DESCRIPTION OF THE INVENTION

A description of example embodiments of the invention follows. The teachings of all patents, published applications and references cited herein are incorporated by reference in their entirety.

Active-matrix LED displays include an array of pixels that can include switching transistors and capacitors. The pixels can be arranged in a grid or matrix. To address a particular pixel, the correct row is turned on (also referred to as switched on), and then a charge is transmitted down the selected column. While this occurs, the other rows that the selected column intersects generally should be turned off so that only the capacitor for the appropriate pixel is charged. The capacitor can hold the charge until it is refreshed during the next cycle.

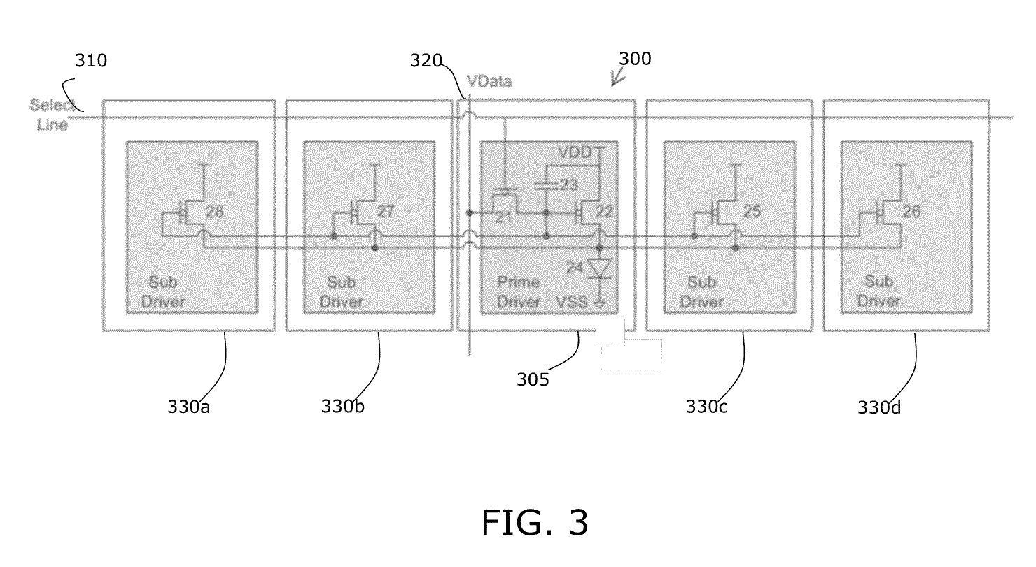

FIG. 3 shows a LED pixel driving circuit 300 in accordance with an embodiment of the present invention. As shown in FIG. 3, the illustrated example embodiment includes a prime driver circuitry 305 and a plurality of sub driver circuitry 330a-330d. Four sub drivers 330a-330d are shown in FIG. 3, but embodiments of the invention can include any practical number of sub drivers. Generally, the more sub drivers employed, the more that the threshold variations are normalized and a more uniform display is achieved.

The LED pixel driving circuit 300 includes a first prime driving transistor 21 with its gate connected to a select line 310, its source connected to a voltage data line 320, and its drain connected to a second prime driving transistor 22. When reference is made to connected, it is meant to refer broadly to any type of connection, including directly or indirectly, that allows for the electrical signal to be communicatively coupled. The select line is used in selecting a particular pixel driving circuit 300 and can be used to turn on the first prime driving transistor 21. Turn on or switch on a transistor refers to applying the appropriate voltage to the gate of the transistor, including depending upon whether it is an N-channel or P-channel transistor, to cause current to flow between the source and the drain.

When the first prime driving transistor 21 is turned on, the voltage data signal on the voltage data line 320 is transmitted from the source of the first prime driving transistor 21 to its drain, which is connected to the gate of second prime driving transistor 22. This causes the second prime driving transistor 22 to turn on and generates a driving current through the second prime driving transistor 22 between its source and the drain. How hard the second prime driving transistor 22 turns on is based on the voltage data signal and can affect in which region the transistor operates and where within a region the transistor operates. The source of the second prime driving transistor 22 is connected to a voltage source, such as Vdd, and the drain of the second prime driving transistor 22 is connected to the anode of a light emitting diode (LED) 24. The cathode of the light emitting diode (LED) 24 can be connected to a voltage source, such as Vss, or to ground depending on the design. The driving current causes the LED 24 to illuminate and provide light.

The drain of the first prime driving transistor 21 also is connected to the gates of the sub driving transistors 25-28 of the sub drivers 330a-330d. Each of the drains of the sub driving transistors 25-28 are connected to the drain of the second prime driving transistor 22, all of which are connected to the anode of the light emitting diode (LED) 24. The sources of each of the sub driving transistors 25-28 are connected to the same voltage source, or power rail, as the source of the second prime driving transistor 22, which is Vdd for this example embodiment. Thus, when the voltage data signal gates the second prime driving transistor 22 and the sub driving transistors 25-28, driving current is supplied to the LED 24 from each of the transistors and differences due to threshold variations are mitigated, and which compensates for the process variations of the second prime driver transistor 22.

The example embodiment illustrated in FIG. 3 uses P-channel transistors for the first and second prime driving transistors 21, 22 and the sub driving transistors 25-28. Other example embodiments can use N-channel transistors or a combination of P-channel and N-channel transistors and can use the appropriate voltage source for the sources and drains of the chosen transistors and for what voltages are applied to the gates of the design specific transistors.

FIG. 3 also illustrates the capacitor 23 that is connected between the source of the second prime driving transistor 22 and the drain of the first prime driving transistor 21. The capacitor 23 is used to store charge so that when the transistors are turned off the driving current can be provided to the LED 24 until the next refresh cycle.

For the example embodiment shown in FIG. 3, the sub driving transistors 25-28 are located in pixels that are neighbors of the pixel having the prime driving circuitry and LED 24. Neighbor pixels can include pixels that are adjacent to the pixel with the prime driving circuitry and LED 24 or that are adjacent to one or more pixels having sub driving circuitry and are collectively adjacent to the pixel having the prime driving circuitry and LED 24 (e.g. a chain as shown in FIG. 3 where pixels 330a and 330b are neighbors of pixel 305 and so are pixels 330c and 330d).

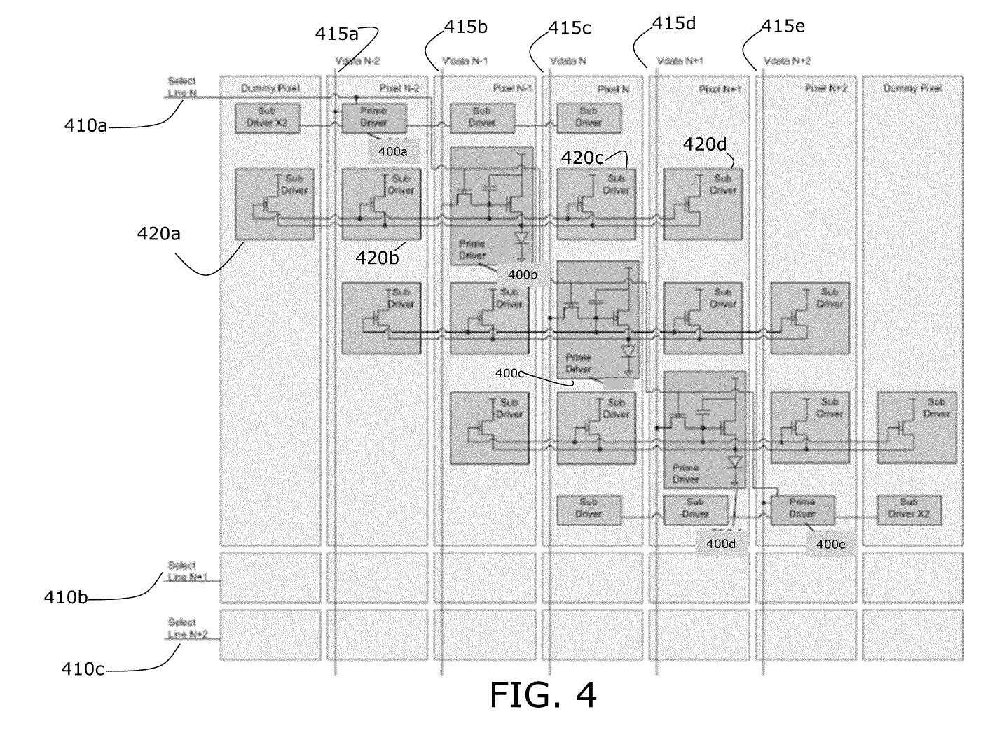

FIG. 4 is a circuit diagram of an LED pixel matrix in accordance with an embodiment of the present invention. For each pixel, the example circuit layout utilizes a prime driver (such as 400a-400e) formed of a first and second prime driving transistors 21, 22, capacitor 23, and LED 24 as described and shown in FIG. 3. Each pixel also uses four sub drivers (for the pixel with prime driver 400b, the sub drivers included with the pixel are neighbor pixels 420a-420d), which are laid out adjacent to the prime driver. The layout is skewed between pixels to account for the sub driver circuitry. The select lines 410a-410c are routed so that they can gate the first prime driving transistors. Similarly, the voltage data lines 415a-415e are routed so that they are connected to the source of the first prime driving transistors. Of course, a wide variety of layouts can be employed in accordance with the present disclosure. For example, sub driver circuitry could be located within the space for the layout of an adjacent pixel or on another layer.

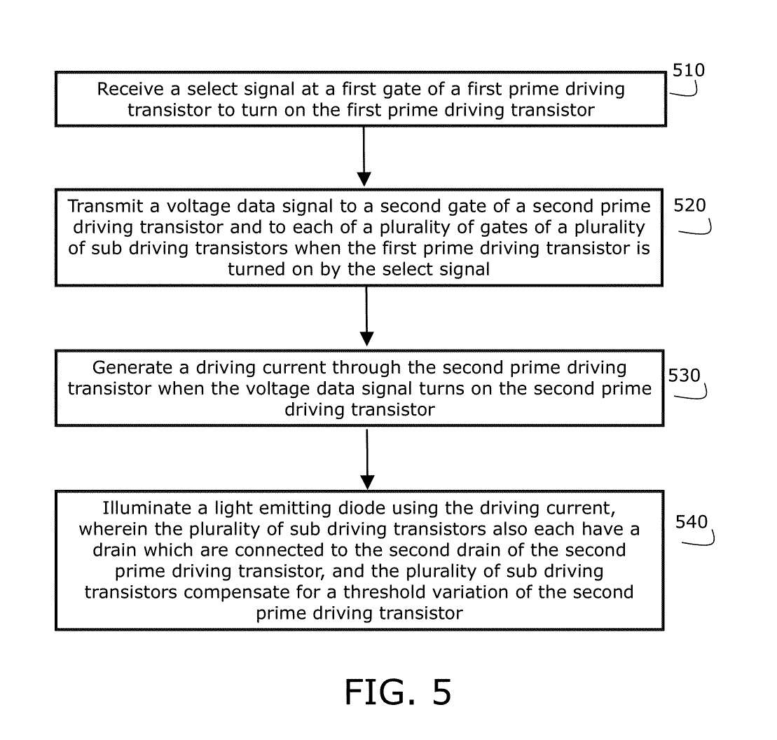

FIG. 5 is a flow diagram illustrating an example embodiment of a method relating to LED pixel driving circuits in accordance with embodiments of the present invention. The layout area illustrated in FIG. 5 provides for (generates) a uniform illumination of LEDs/pixels on a display panel or other screen. In accordance with this example method, first a select signal is received 510 at a first gate of a first prime driving transistor to turn on the first prime driving transistor. Then, a voltage data signal is transmitted 520 to a second gate of a second prime driving transistor and to each of a plurality of gates of a plurality of sub driving transistors when the first prime driving transistor is turned on by the select signal. The plurality of sub driving transistors also each have a drain which are connected to the second drain of the second prime driving transistor. This provides for the plurality of sub driving transistors to compensate for a threshold variation of the second prime driving transistor. A driving current is then generated 530 through the second prime driving transistor when the voltage data signal turns on the second prime driving transistor. The driving current is used to illuminate 540 a light emitting diode.

While this invention has been particularly shown and described with references to example embodiments thereof, it will be understood by those skilled in the art that various changes in form and details may be made therein without departing from the scope of the invention encompassed by the appended claims.

What is claimed is:

1. A light emitting diode pixel driving circuit comprising:
a first prime driving transistor having a first gate and a first source;
a select line connected to the first gate;
a voltage data line connected to the first source;
a second prime driving transistor having a second gate and a second drain;
a light emitting diode connected to the second drain; and
a plurality of sub driving transistors each having a gate and a drain wherein the gates of the plurality of sub driving transistors are connected to the second gate and the drains of the sub driving transistors are connected to the second drain.

2. The circuit of claim 1 wherein the first and second prime driving transistors are located in a first pixel and the plurality of sub driving transistors are located outside the first pixel.

3. The circuit of claim 1 wherein the first and second prime driving transistors are located in a first pixel and each of the plurality of sub driving transistors are located in a neighbor pixel to the first pixel.

4. The circuit of claim 1 wherein the first and second prime driving transistors are P-channel transistors.

5. The circuit of claim 1 wherein the plurality of sub driving transistors are each P-channel transistors.

6. The circuit of claim 1 wherein the second prime driving transistor also has a second source and further comprising a capacitor connected between the second source and the second gate.

7. The circuit of claim 1 wherein the second prime driving transistor also has a second source and further comprising a VDD voltage source that is connected to the second source.

8. The circuit of claim 7 wherein the plurality of sub driving transistors also each have a source and wherein the VDD voltage source is also connected to the sources of the plurality of sub driving transistors.

9. The circuit of claim 1 wherein the first gate is capable of receiving a select signal through the select line and the first source is capable of receiving a voltage data signal through the voltage data line.

10. The circuit of claim 9 wherein the voltage data signal is transmitted to the second gate when the first prime driving transistor is turned on by the select signal, and a voltage level of the voltage data signal is configured to turn on the second prime driving transistor to generate a driving current through the second prime driving transistor.

11. The circuit of claim 1 wherein the plurality of sub driving transistors are capable of compensating for a threshold variation of the second prime driving transistor resulting in an improved uniform illumination of the light emitting diode on a display panel.

12. A method comprising:
receiving a select signal at a first gate of a first prime driving transistor to turn on the first prime driving transistor;
transmitting a voltage data signal to a second gate of a second prime driving transistor and to each of a plurality of gates of a plurality of sub driving transistors when the first prime driving transistor is turned on by the select signal;
generating a driving current through the second prime driving transistor when the voltage data signal turns on the second prime driving transistor;
illuminating a light emitting diode using the driving current; and
wherein the plurality of sub driving transistors also each have a drain which are connected to the second drain of the second prime driving transistor, and the plurality of sub driving transistors drive current and compensate for a threshold variation of the second prime driving transistor.

13. The method of claim 12 wherein the first and second prime driving transistors are located in a first pixel and the plurality of sub driving transistors are located outside the first pixel.

14. The method of claim 12 wherein the first and second prime driving transistors are located in a first pixel and each of the plurality of sub driving transistors are located in a neighbor pixel to the first pixel.

15. The method of claim 12 wherein the first and second prime driving transistors are P-channel transistors.

16. The method of claim 12 wherein the plurality of sub driving transistors are each P-channel transistors.

17. The method of claim 12 wherein the second prime driving transistor also has a second source and further comprising providing current to the light emitting diode from a capacitor which is connected between the second source and the second gate when the first prime driving transistor is turned off.

18. The method of claim 12 wherein the second prime driving transistor also has a second source and the plurality of sub driving transistors also each have a source, and further comprising a VDD voltage source that is connected to the second source and to the sources of the plurality of sub driving transistors.

19. The method of claim 12 wherein the select signal is received through a select line and the voltage data signal is transmitted through a voltage data line.

20. The method of claim 12 wherein the plurality of sub driving transistors compensate for a threshold variation of the second prime driving transistor so as to result in an improved uniform illumination of the light emitting diode on a display panel.
